(19) United States
(12) Patent Application Publication
(10) Pub. No.: US 2026/0358646 A1
(43) Pub. Date: Nov. 12, 2026

(54) OPTICAL APPARATUS, OPTICAL ELEMENT, AND DISPLAY APPARATUS

(71) Applicant: CANON KABUSHIKI KAISHA, Tokyo (JP)

(72) Inventor: Yu MIYAJIMA, Tokyo (JP)

(21) Appl. No.: 19/649,229

(22) Filed: Apr. 16, 2026

(30) Foreign Application Priority Data
May 12, 2025 (JP) 2025-079147

(51) Int. Cl. G02B 27/28; G02B 27/00; G02B 27/01

(52) U.S. Cl. CPC G02B 27/286; G02B 27/0075; G02B 27/0172; G02B 2027/0114

(57) ABSTRACT

An optical apparatus configured to guide a light beam from a display surface of a display element to a pupil plane may include an optical system configured to guide a light beam having a specific polarization state to the pupil plane, and a display element shift unit configured to shift the display element in a direction perpendicular to an optical axis of the optical system.

### BACKGROUND

### Field of the Technology

The present disclosure relates to an optical apparatus, an optical element, and a display apparatus.

### Description of Related Art

Japanese Patent Application Laid-Open No. 9-322099 discloses an image display apparatus having a display surface formed by arranging a plurality of pixels.

### SUMMARY

An optical apparatus according to one aspect of the present disclosure may be configured to guide a light beam from a display surface of a display element to a pupil plane. The optical apparatus may include an optical system configured to guide a light beam having a specific polarization state to the pupil plane, and a display element shift unit configured to shift the display element in a direction perpendicular to an optical axis of the optical system. Alternatively, the optical apparatus may include an optical system configured to guide a light beam having a specific polarization state to the pupil plane, a light beam shift unit configured to shift the light beam in a direction perpendicular to an optical axis of the optical system by changing a polarization state of the light beam, and a polarization adjuster configured to adjust the light beam shifted by the light beam shift unit so that the light beam has a specific polarization state. A display apparatus having the above optical apparatus also constitutes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIGS. 1A and 1B are a cross-sectional view and an aberration diagram, respectively, of an observation apparatus according to Example 1.

FIG. 2 is a schematic diagram illustrating an optical path of the observation apparatus according to Example 1.

FIGS. 3A and 3B are a cross-sectional view and an aberration diagram, respectively, of the observation apparatus after diopter adjustment according to Example 1.

FIGS. 4A and 4B are a cross-sectional view and an aberration diagram, respectively, of an observation apparatus according to Example 2.

FIG. 5 is an explanatory diagram of a super-resolution element according to Example 2.

FIGS. 6A and 6B are explanatory diagrams of a first transmissive-reflective surface and a second transmissive-reflective surface.

FIG. 7 is a diagram illustrating an emission angle β of a display element relative to an angle of view α in Example 2.

### DETAILED DESCRIPTION

Referring now to the accompanying drawings, a detailed description will be given of embodiments according to the present disclosure.

The optical apparatus according to each example is an observation apparatus including an observation optical system (a folding optical system) that guides a light beam from a display surface of a display element to an observation surface (pupil plane). The observation optical system is an optical system for observing an image displayed on the display surface. A display apparatus includes the optical system and the display element according to each example.

The optical system according to each example includes, in order from the pupil plane side to the display surface side, a first optical system (pupil-plane-side optical system), a first transmissive-reflective member, a second optical system (transmissive-reflective optical system), a second transmissive-reflective member, and a third optical system (display-element-side optical system).

The first transmissive-reflective member has a first transmissive-reflective surface having a curved surface. The second transmissive-reflective member has a second transmissive-reflective surface having a curved surface.

The first optical system is an optical system disposed between the pupil plane and the first transmissive-reflective member. The second optical system is an optical system disposed between two transmissive-reflective surfaces (the first transmissive-reflective surface and the second transmissive-reflective surface) that each serve as both a transmissive surface and a reflective surface. The third optical system is an optical system disposed between the second transmissive-reflective surface and the display element and does not include an element having refractive power or diffractive power.

Each example will be described in detail below.

### Example 1

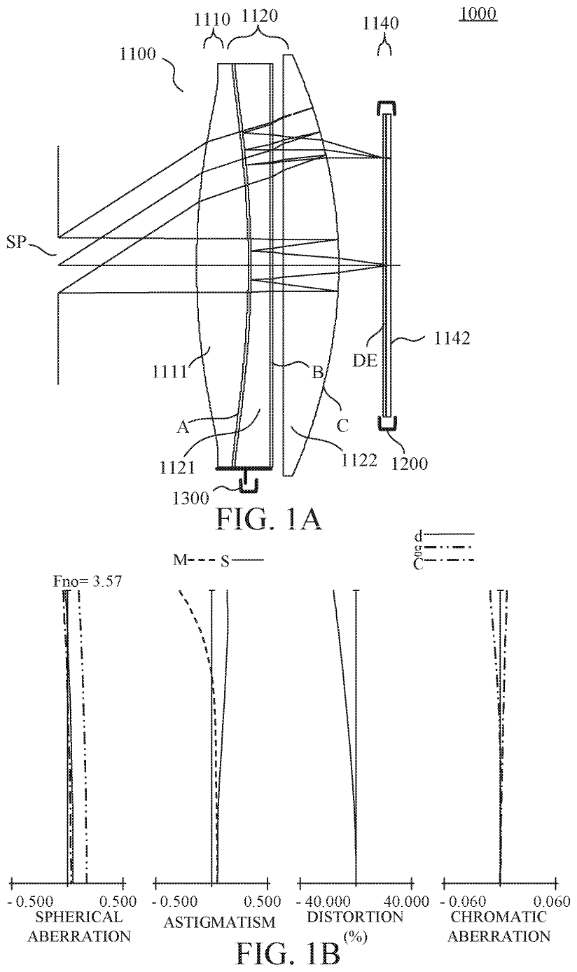

First, the optical configuration of an observation apparatus (optical apparatus) 1000 according to Example 1 will be described. FIG. 1A is a cross-sectional view of the observation apparatus 1000. The observation apparatus 1000 includes an observation optical system 1100, a display element shift unit 1200, and a diopter adjustment mechanism 1300. The observation optical system 1100 includes a pupil-plane-side optical system (first optical system) 1110, a first transmissive-reflective member A, a transmissive-reflective optical system (second optical system) 1120, a second transmissive-reflective member (C), and a display-element-side optical system (third optical system) 1140.

The pupil-plane-side optical system 1110 includes an optical element (third lens) 1111 having positive on-axis power. The transmissive-reflective optical system 1120 is disposed between the first transmissive-reflective member and the second transmissive-reflective member, and includes an optical element (second lens) 1121 and an optical element (first lens) 1122. Thus, in the present example, the pupil-plane-side optical system 1110 includes one optical element that refracts, reflects, or diffracts light rays, and the transmissive-reflective optical system 1120 includes two such optical elements (optical elements 1111, 1121, and 1122).

Each optical element has two optical surfaces, referred to as an R1 surface and an R2 surface in order from the pupil plane side. Both the R1 surface and the R2 surface of the optical element 1111 are curved surfaces. The R1 surface of the optical element 1121 is a curved surface and the R2 surface of the optical element 1121 is a planar surface. The R1 surface of the optical element 1122 is a planar surface and the R2 surface of the optical element 1122 is a curved surface.

Light rays from the display surface of the display element 1142 pass through the transmissive-reflective optical system 1120, are reflected by the first transmissive-reflective surface, are reflected by the second transmissive-reflective surface, pass again through the transmissive-reflective optical system 1120 and the pupil-plane-side optical system 1110, and travel toward a pupil plane SP. Thereby, the observation apparatus 1000 enables observation, from the pupil plane SP at which an exit pupil is located, of an optical image on the display surface of the display element 1142. Light that follows this optical path will be referred to as desired light, and other light will be referred to as unnecessary light.

FIG. 1B is an aberration diagram of the observation apparatus 1000 in a case where an eye relief (a distance from the pupil plane SP to a pupil-facing surface of the pupil-plane-side optical system 1110, which is the lens surface closest to the pupil plane of the pupil-plane-side optical system 1110) is 15 mm and a virtual image is displayed at a position of 1600 mm from the pupil plane SP. FIG. 1B illustrates aberrations at wavelengths of the d-line (587.6 nm), F-line (486.1 nm), and C-line (656.3 nm), which are design reference wavelengths. It is understood from FIG. 1B that chromatic aberration and curvature of field are sufficiently reduced and satisfactory imaging performance is obtained.

FIG. 1B illustrates aberrations obtained by a reverse optical path (reverse tracing) from the pupil plane SP toward the display surface of the display element 1142, with the display surface serving as an image plane, rather than by an original forward optical path (forward tracing) from the display surface of the display element 1142 toward the pupil plane SP. This does not present a problem because the aberrations correspond to those in the forward optical path (forward tracing) when the optical performance of the observation optical system 1100 is illustrated. Examples of approximate property of each element, such as a polarizing plate, a quarter waveplate, and a polarization-selective transmissive-reflective element described later, are as follows. The polarizing plate has a thickness of 0.1 mm, a refractive index of 1.52, and an Abbe number of 50. The quarter waveplate and a laminated element of the quarter waveplate and the polarization-selective transmissive-reflective element are uniformly described as having a thickness of 0.3 mm, a refractive index of 1.52, and an Abbe number of 50, although actual properties may differ.

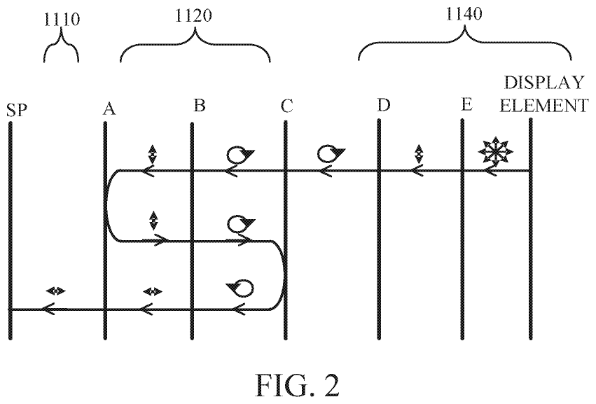

Next, with reference to FIG. 2, an optical path of the observation apparatus 1000 will be described. FIG. 2 is a schematic diagram illustrating the optical path of the observation apparatus 1000, illustrating the direction of the optical path through respective surfaces and polarization states above the path. Here, the optical path of the desired light will be described, and a description of the optical path of the unnecessary light caused by respective components of the observation apparatus 1000 will be omitted.

The observation apparatus 1000 includes, in order from the pupil plane SP, the pupil-plane-side optical system 1110, a polarization-selective transmissive-reflective element A, the transmissive-reflective optical system 1120, a first quarter waveplate B, a transmissive-reflective surface (half-mirror) C, and the display-element-side optical system 1140. The polarization-selective transmissive-reflective element A corresponds to the first transmissive-reflective member having the first transmissive-reflective surface. The transmissive-reflective surface C corresponds to the second transmissive-reflective member having the second transmissive-reflective surface. The display-element-side optical system 1140 includes a display element (light modulation element), such as a liquid crystal display element or an organic EL element, a polarizing plate E, and a second quarter waveplate D. In the present example, the display element is an organic EL element. The display element has a square shape with a diagonal of 1.3 inches (one side being 23.3 mm). The polarizing plate E and the second quarter waveplate D are disposed in this order from the display element toward the pupil plane side.

Unpolarized light emitted from the display element is converted into linearly polarized light by the polarizing plate E, converted into circularly polarized light by the second quarter waveplate D, and directed toward the transmissive-reflective optical system 1120. The polarizing plate E may be integrated with the display element. For example, many liquid crystal display elements include a polarizing plate in their structure. Also, in an organic EL element, a polarizing plate may be used for antireflection purposes, and in such a case, emitted light from the display element is linearly polarized. In such cases, the separate polarizing plate E may be omitted.

The polarization-selective transmissive-reflective element A and the transmissive-reflective surface (half-mirror) C are two transmissive-reflective surfaces (the first transmissive-reflective surface and the second transmissive-reflective surface) each serving as both a transmissive surface and a reflective surface. The transmissive-reflective surface C is formed of a dielectric multilayer film or a metal film and functions as the second transmissive-reflective surface. The thickness of the transmissive-reflective surface C is typically 1000 nm or less, and at most 5000 nm or less. In the present example, this thickness is not taken into consideration.

The first quarter waveplate B is disposed such that its slow axis is tilted by 90° relative to that of the second quarter waveplate D, and such that the slow axis of the first quarter waveplate B is tilted by 45° relative to a transmission axis of the polarizing plate E. The transmissive-reflective surface C is deposited on the R2 surface of the optical element 1122. The first quarter waveplate B is bonded to the R2 surface of the optical element 1121.

The polarization-selective transmissive-reflective element A is configured to reflect linearly polarized light having the same polarization direction as that of light that has passed through the polarizing plate E, and to transmit linearly polarized light having a polarization direction orthogonal thereto. That is, the polarization-selective transmissive-reflective element A is a reflective polarizer that separates incident light into reflected light and transmitting light according to a polarization state, and may be, for example, a wire-grid polarizer or a multilayer birefringent film polarizer. As a specific example of a wire-grid polarizer, “WGF” manufactured by Asahi Kasei Corporation may be used, and a wire-grid forming surface functions as the transmissive-reflective surface. The thickness of the polarization-selective transmissive-reflective element A is typically 0.5 mm or less, and at most 1 mm or less. The polarization-selective transmissive-reflective element A is bonded to the R2 surface of the optical element 1111.

The transmissive-reflective member includes a transmissive-reflective surface and a member continuous with the transmissive-reflective surface, has substantially no refractive power, and mainly provides optical functions other than refraction (such as absorption according to the polarization state, change in the polarization state, and antireflection) and mechanical functions (such as bonding and protection). In the present example, the polarization-selective transmissive-reflective element A is the first transmissive-reflective member, and the transmissive-reflective surface (half-mirror) C is the second transmissive-reflective member. Each transmissive-reflective member may include a plurality of members having different functions.

Of light incident on the transmissive-reflective surface C, the desired light passes therethrough, is converted by the first quarter waveplate B into linearly polarized light having the same polarization direction as that of light that has passed through the polarizing plate E, and enters the polarization-selective transmissive-reflective element A. This linearly polarized light is reflected by the polarization-selective transmissive-reflective element A. The reflected light is converted by the first quarter waveplate B into circularly polarized light in the same direction as that when initially converted by the second quarter waveplate D, and enters the transmissive-reflective surface C, where it is reflected. The light reflected by the transmissive-reflective surface C becomes circularly polarized light in a direction opposite to that before reflection, again enters the first quarter waveplate B, and is converted into linearly polarized light having a polarization direction orthogonal to that when initially passing through the polarizing plate E, and enters the polarization-selective transmissive-reflective element A. This linearly polarized light transmits through the polarization-selective transmissive-reflective element A due to its polarization selectivity and is guided to the pupil plane SP.

The features of the present disclosure will now be described. As described above, HMDs are demanded to have a reduced size (thickness) and an increased resolution. Conventionally, development has progressed toward reducing the pixel size of a display element to increase resolution; however, technical challenges have recently limited significant improvement. Increasing resolution by enlarging the display element and increasing the number of pixels results in a higher cost and enlargement (thickening) of the observation optical system corresponding to the larger display element.

Accordingly, the present example uses a polarization optical system as the observation optical system 1100. At least one of the first transmissive-reflective member and the second transmissive-reflective member is a transmissive-reflective member that transmits or reflects a light beam according to the polarization state. A polarization optical system that includes the first transmissive-reflective member and the second transmissive-reflective member and folds an optical path in an optical axis direction for a light beam having a specific polarization state is highly effective in reducing thickness. Providing curved reflective surfaces in the first transmissive-reflective member and the second transmissive-reflective member can reduce a Petzval sum and curvature of field, and thereby secure high optical performance.

The present example improves the resolution by sacrificing temporal resolution and improving spatial resolution. More specifically, the display element 1142 is held by the display element shift unit 1200. The display element shift unit 1200 is configured to shift in two directions perpendicular to the optical axis (an X direction (first direction) and a Y direction (second direction)). The display element has pixels each having a size of 6 μm, arranged in 3891×3891 in the X direction and the Y direction.

In a high-resolution mode, the display element shift unit 1200 repeatedly performs an operation of shifting the display element 1142 at high speed in the X direction and the Y direction and holding it for a predetermined time. More specifically, let shift amounts in the X direction and the Y direction be (ΔX, ΔY). Then, the operation is repeated with (0 μm, 0 μm)→(3 μm, 0 μm)→(3 μm, 3 μm)→(0 μm, 3 μm) as one cycle. By performing one cycle at a speed of 30 fps or more, which is a frame rate of human vision, a user recognizes superimposed images as a single image. By shifting by 3 μm, which is half of one pixel, in the X and Y directions and displaying images corresponding to respective positions, spatial resolution may appear doubled in both the X direction and the Y direction to the user. The shift amount may be 1/n (where n is an integer) of a pixel size, although other shift amounts may be used to achieve higher resolution. The shift amount may be set according to a pixel arrangement of the display element, such as a square arrangement in orthogonal X and Y directions or a honeycomb arrangement in which adjacent pixels are diagonally arranged.

The present example can improve the resolution in two directions (X and Y), but is not limited to this example, and may improve the resolution in a single direction.

The present example can switch between a resolution improving mode and a normal mode (without resolution improving processing). That is, the display element shift unit 1200 may be switched between driven and non-driven states. Thereby, the present example enables observation according to intended use, according to whether spatial resolution is to be improved at the expense of temporal resolution. For example, the display element is shifted according to the display content of the display element, e.g., the display element shift unit 1200 may be driven in a case where a still image is displayed and may be non-driven in a case where a moving image is displayed. Display content is not limited to a still image and a moving image, and may include a VR image or a polygon image. The display element shift unit 1200 may determine whether to shift the display element based on user instruction (or user setting).

In observing an image with little motion, such as a still image, temporal resolution is less important and the high-resolution mode may be beneficial. In observing an image with significant motion, such as a moving image, temporal resolution is important and the normal mode may be beneficial. Manual switching is useful; however, automatic switching based on display content may also be employed.

In improving the resolution, the chromatic aberration of the observation optical system may be reduced. It is effective to reduce the chromatic aberration in the transmissive-reflective optical system, through which light passes three times, rather than in the pupil-plane-side optical system or the display-element-side optical system, through which light passes only once. More specifically, lenses having positive and negative on-axis power are provided, and the following inequality (1) may be satisfied:

20≤v1−v2 (1)
where v1 and v2 are Abbe numbers of the lenses having positive and negative on-axis power based on the d-line.

Inequality (1) may be replaced with the following inequality (1a):

25≤v1−v2 (1a)

Inequality (1) may be replaced with the following inequality (1b):

30≤v1−v2 (1b)

In the present example, the transmissive-reflective optical system 1120 includes an optical element (first lens) 1122 having positive on-axis power and an optical element (second lens) 1121 having negative on-axis power. Letting an Abbe number of the optical element 1122 based on the d-line be v1 and an Abbe number of the optical element 1121 based on the d-line be v2, v1=56.0 and v2=22.38; thus, 30≤v1−v2=34.62 is satisfied, and inequality (1) is satisfied.

To reduce the sensitivity of the imaging performance to factors other than the chromatic aberration, such as manufacturing tolerances and placement tolerances, a power difference between the lens having the positive on-axis power and the lens having the negative on-axis power described above may not be large. More specifically, letting a paraxial focal length of the lens having positive on-axis power (optical element 1122 in the present example) be f1 and a paraxial focal length of the lens having negative on-axis power (optical element 1121 in the present example) be f2, the following inequality (2) may be satisfied.

0.25≤|f2/f1|≤4.00 (2)

Inequality (2) may be replaced with the following inequality (2a):

0.50≤|f2/f1|≤3.00 (2a)

Inequality (2) may be replaced with the following inequality (2b):

1.00≤|f2/f1|≤2.00 (2b)

In the present example, f1=94.3 mm and f2=−159.8 mm; thus, 0.25≤|f2/f1|=1.69≤4 is satisfied, and inequality (2) is satisfied.

If a distance from an optical surface facing the pupil plane SP (pupil-facing surface) to the display surface of the display element is 30 mm or less, the apparatus may be considered small (thin), and a distance of 25 mm or less may be used. In the present example, a distance from the pupil-facing surface to the display element is 21.0 mm, and thus the apparatus can be considered sufficiently compact (thin).

To achieve the size reduction (thickness reduction), a focal length of the optical system may be reduced. For example, a configuration in which on-axis power of the pupil-plane-side optical system is positive can be used. From the viewpoint of imaging performance, on-axis power of the transmissive-reflective optical system is positive. Thereby, on-axis power is positive in both optical systems, and a focal length can be more readily reduced as compared with a configuration in which on-axis power of the pupil-plane-side optical system is negative. In the present example, the pupil-plane-side optical system 1110 has a focal length of 95.7 mm and has positive on-axis power. This reduces the focal length and is beneficial for size reduction (thickness reduction).

In the present example, an R1 surface of the optical element 1111 that forms the pupil-facing surface facing the pupil plane SP has a convex shape toward the pupil plane SP. Considering reverse tracing of the optical path from the pupil plane SP, when the pupil-facing surface is planar or convex, refraction of a light beam at the pupil-facing surface increases as compared with a case where the pupil-facing surface has a concave shape toward the pupil plane SP; thus, the optical system can be reduced in size in a radial direction. Further, in a case where the pupil-facing surface has a concave shape toward the pupil plane SP, the optical surface protrudes toward the pupil plane side from the eye relief, which is not satisfactory in terms of interference with the eye. In particular, when a holder for an optical element that forms the pupil-facing surface is included, further protrusion may occur. Thus, the pupil-facing surface may be at least planar, and may be convex toward the pupil plane SP.

In the present example, the first quarter waveplate B is bonded to the R2 surface of the optical element 1121, which is planar. That is, the first quarter waveplate B is a planar phase shifter. Thus, the first quarter waveplate B may not be bent as compared with a case where a bonding surface is curved, and manufacturability can be improved.

In the present example, an air gap is formed between the optical element 1121 and the optical element 1122. That is, the transmissive-reflective optical system 1120 includes an air gap. As compared with a configuration in which the space is filled with an optical material, this configuration can achieve size reduction (thickness reduction) and weight reduction.

In the present example, using the air gap described above, the observation apparatus includes a diopter adjustment mechanism (adjuster) 1300 that integrally defocuses the optical element 1111 and the optical element 1121, which have the first transmissive-reflective surface. The diopter adjustment mechanism 1300 adjusts a focus state by changing the air gap. Thus, focus adjustment (diopter adjustment) according to a user's diopter can be performed.

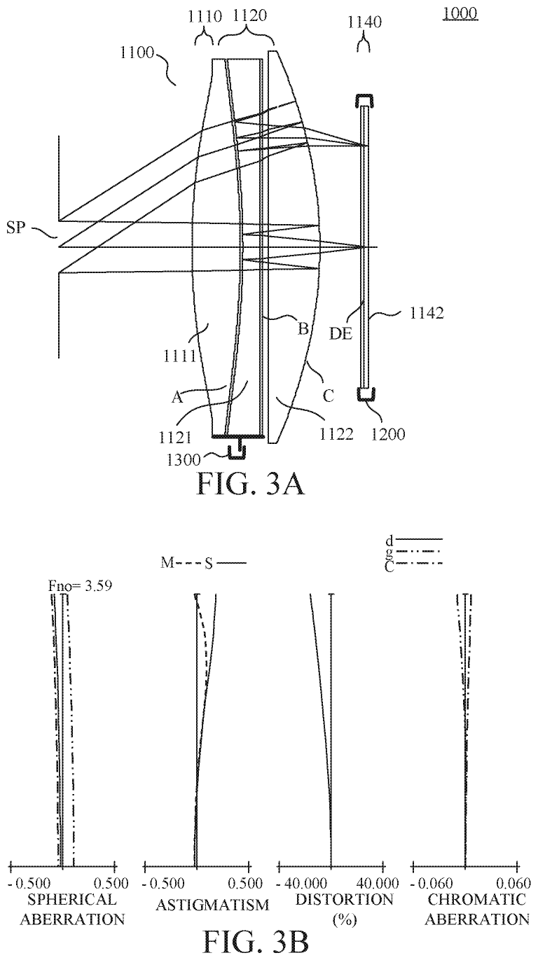

FIG. 3A and FIG. 3B are a cross-sectional view and an aberration diagram, respectively, of the observation apparatus after diopter adjustment in the present example. FIG. 3A illustrates an optical path diagram in a case where diopter adjustment is performed for a person having-4D (myopia). FIG. 3B illustrates an aberration diagram in that case. As illustrated in FIG. 3B, sufficiently satisfactory imaging performance can be obtained even after diopter adjustment.

Since the sensitivity of a focus position is high relative to a distance between the first transmissive-reflective surface and the second transmissive-reflective surface, when diopter adjustment is performed, a drive amount can be reduced. Thus, the configuration that performs diopter adjustment can reduce the size (thickness) and weight.

### Example 2

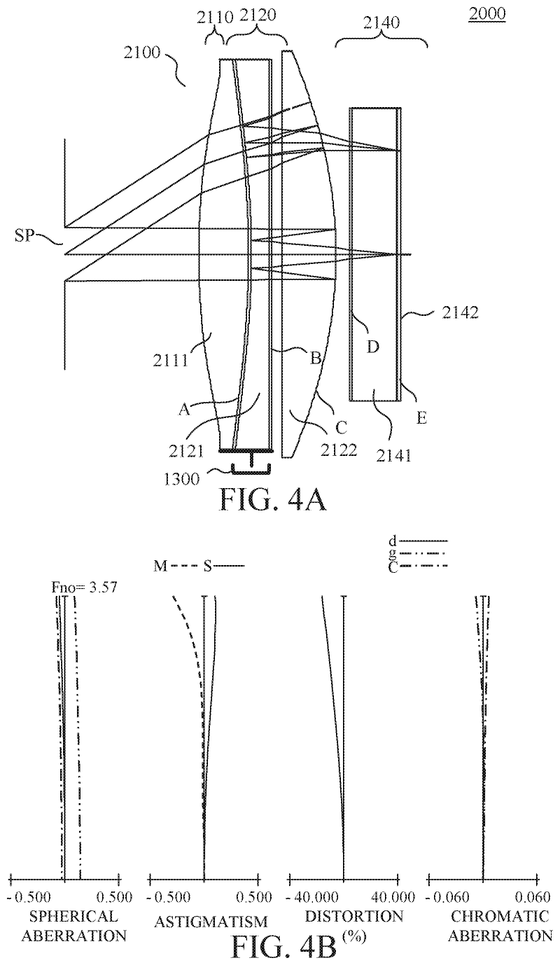

Next, an observation apparatus (optical apparatus) 2000 according to Example 2 will be described. A description common to Example 1 will be omitted. FIG. 4A is a cross-sectional view of the observation apparatus 2000. The observation apparatus 2000 includes an observation optical system 2100 and the diopter adjustment mechanism 1300. The observation optical system 2100 includes a pupil-plane-side optical system (first optical system) 2110, a first transmissive-reflective member (A), a transmissive-reflective optical system (second optical system) 2120, a second transmissive-reflective member (C), and a display-element-side optical system (third optical system) 2140.

The observation apparatus 2000 differs from the observation apparatus 1000 of Example 1 in that the observation apparatus 2000 does not include the display element shift unit 1200 and includes the observation optical system 2100 instead of the observation optical system 1100. The observation optical system 2100 differs from the observation optical system 1100 in that the observation optical system 2100 includes the display-element-side optical system 2140 instead of the display-element-side optical system 1140. The display-element-side optical system 2140 differs from the display-element-side optical system 1140 in that the display-element-side optical system 2140 includes a super-resolution element (optical element) 2141 between the polarizing plate E and the second quarter waveplate D. The super-resolution element 2141 is integrated with the polarizing plate E and the second quarter waveplate D. However, the present example is not limited to this example; the super-resolution element 2141 may be configured separately from at least one of the polarizing plate E and the second quarter waveplate D.

As described later in detail, the present example uses the super-resolution element 2141, and improves spatial resolution in two directions perpendicular to the optical axis (an X direction (first direction) and a Y direction (second direction)), thereby improving the resolution.

The present example can switch between a high-resolution mode and a normal mode (a mode without resolution improving processing). Thereby, observation may be performed according to intended use, according to whether spatial resolution is to be improved at the expense of temporal resolution. A light beam shift unit of the super-resolution element 2141 may determine whether to shift a light beam according to the display content of the display element (such as a moving image, a still image, a VR image, and a polygon image). The light beam shift unit may determine whether to shift the light beam according to a user instruction (a user setting).

FIG. 4B is an aberration diagram of the observation optical system 2100 in a case where an eye relief (a distance from the pupil plane SP to a pupil-facing surface of the pupil-plane-side optical system 2110, which is the lens surface closest to the pupil plane) is 15 mm and a virtual image is displayed at a position 1600 mm from the pupil plane SP. FIG. 4B illustrates aberrations at wavelengths of the d-line (587.6 nm), F-line (486.1 nm), and C-line (656.3 nm), which are design reference wavelengths. It is understood from FIG. 4B that chromatic aberration and curvature of field are sufficiently reduced and satisfactory imaging performance is obtained.

FIG. 4B illustrates aberrations obtained by a reverse optical path (reverse tracing) from the pupil plane SP toward the display surface of the display element 2142, with the display surface serving as an image plane, rather than by an original forward optical path (forward tracing) from the display surface toward the pupil plane SP. This does not present a problem because the aberrations correspond to those in the forward optical path (forward tracing) when the optical performance of the observation optical system 2100 is illustrated. An example of approximate property of the super-resolution element 2141, a thickness of 5.0 mm, a refractive index of 1.4917, and an Abbe number of 57.4 are uniformly used, although actual properties may differ.

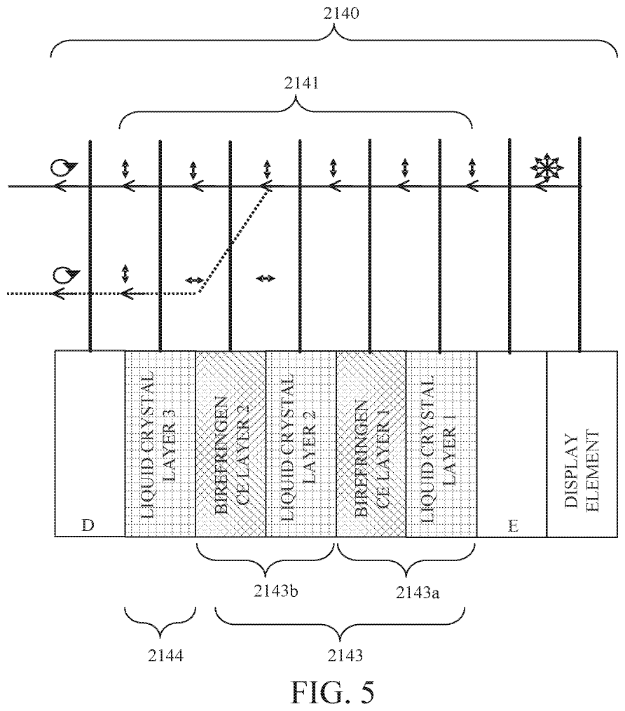

Next, with reference to FIG. 5, the structure and optical path of the super-resolution element 2141 will be described. FIG. 5 is a schematic diagram illustrating an optical path in the display-element-side optical system 2140, illustrating the direction of the optical path through respective surfaces and polarization states above the optical path. Here, the optical path of the desired light will be described, and a description of the optical path of the unnecessary light caused by respective components of the display-element-side optical system 2140 will be omitted.

The super-resolution element 2141 includes birefringent layers 1 and 2 and liquid crystal layers 1, 2, and 3. The birefringent layer 1 is sandwiched between the liquid crystal layer 1 and the liquid crystal layer 2. The birefringent layer 2 is sandwiched between the liquid crystal layer 2 and the liquid crystal layer 3. Each liquid crystal layer has a function of switching incident linearly polarized light to linearly polarized light differing by 90°. Each birefringent layer is generally referred to as a Savart plate and has a function of shifting a light ray according to the direction of incident linearly polarized light due to birefringence.

First, a reference optical path indicated by a solid line in FIG. 5 will be described. Unpolarized light emitted from the display element is converted into linearly polarized light by the polarizing plate E and enters the liquid crystal layer 1. Without switching the polarization state in the liquid crystal layer 1, the light passes through the birefringent layer 1 and enters the liquid crystal layer 2. Without switching the polarization state in the liquid crystal layer 2, the light passes through the birefringent layer 2 and enters the liquid crystal layer 3. Without switching the polarization state in the liquid crystal layer 3, the light enters the second quarter waveplate D, is converted into circularly polarized light, and travels toward the transmissive-reflective optical system 2120.

Next, an optical path in a case where a light beam is shifted in the Y direction, indicated by a dotted line in FIGS. 4A and 4B, will be described. Unpolarized light emitted from the display element is converted into linearly polarized light by the polarizing plate E and enters the liquid crystal layer 1. Without switching the polarization state in the liquid crystal layer 1, the light passes through the birefringent layer 1 and enters the liquid crystal layer 2. The polarization state is switched in the liquid crystal layer 2, and the light passes through the birefringent layer 2 while being shifted in the Y direction, and enters the liquid crystal layer 3. In the liquid crystal layer 3, the polarization state is switched to be the same as in the reference optical path, and the light enters the second quarter waveplate D, is converted into circularly polarized light, and travels toward the transmissive-reflective optical system 2120.

Thus, by switching (changing) the polarization state in the liquid crystal layer 2, a light ray can be shifted in the Y direction in the birefringent layer 2. Although a detailed description will be omitted, similarly, by switching the polarization state in the liquid crystal layer 1, a light ray can also be shifted in the X direction in the birefringent layer 1. That is, the liquid crystal layer 1 and the birefringent layer 1 form a light beam shift unit 2143 (2143a) that shifts a light beam in the X direction, and the liquid crystal layer 2 and the birefringent layer 2 form a light beam shift unit 2143 (2143b) that shifts a light beam in the Y direction. Regardless of which shift is produced, the imaging performance in the polarization optical system can be maintained by adjusting, in the liquid crystal layer 3, a polarization state of light traveling to an optical system downstream so as to be constant. That is, the liquid crystal layer 3 is a polarization adjuster 2144.

Thereby, while the imaging performance in the polarization optical system is maintained, the spatial resolution in the X direction and the Y direction can be improved and the resolution can be improved.

However, a specific structure of the super-resolution element 2141 described in the present example is merely an example, and a configuration for switching a polarization state, a configuration for shifting a light beam, and the like are not limited to the liquid crystal layers and the birefringent layers described above. A polarization state to be switched is not limited to a linear polarization state.

An optical system downstream of the super-resolution element 2141 according to the present example is not limited to the polarization optical system described above. For example, when the polarization states are aligned, countermeasures against external light may be facilitated. Since strict imaging performance differs according to the polarization state, when the polarization states are aligned, the uniformity of imaging performance can be more readily secured. The super-resolution element 2141 can improve the resolution, and these effects can be obtained, without limiting the downstream optical system to a polarization optical system.

In the present example, the light beam shift unit 2143 shifts a light beam by switching a polarization state according to an electrical signal; however, the present example is not limited to this example.

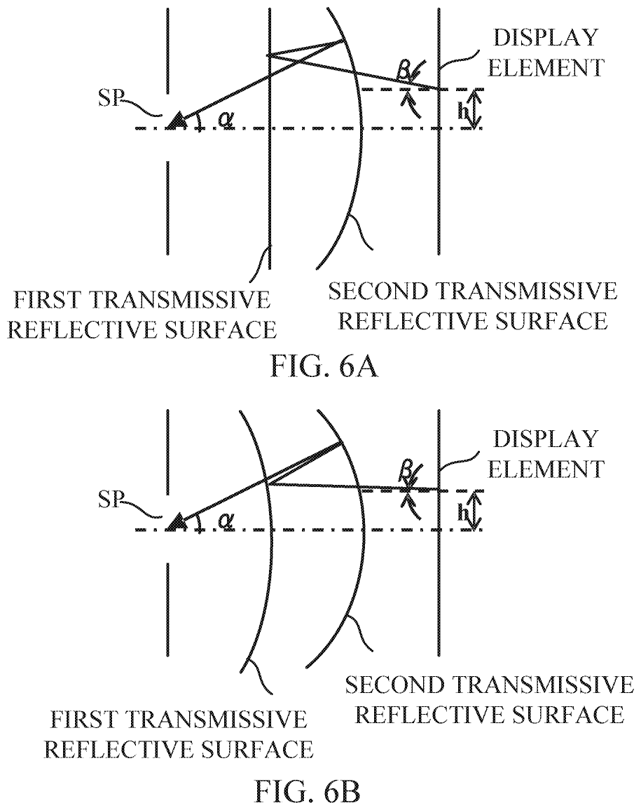

Next, an emission angle of the display element will be described. FIGS. 6A and 6B are schematic diagrams for describing, according to a plano-convex shape of the first transmissive-reflective surface, an optical path of a light ray emitted from an image height h on the display element, an emission angle β of the display element, and an angle of view α on the pupil plane SP. Here, in order to explain effects of reflection, effects of refraction are not illustrated. For a simple description, an approximately spherical shape is used for the discussion instead of a complex aspherical shape.

Since the display element typically exhibits Lambertian emission, a smaller emission angle β results in a larger amount of light being captured, and a larger emission angle β results in a smaller amount of light being captured. Therefore, in a range of a design field angle, if the emission angle β is large, unevenness in light amount may occur in a field of view.

FIG. 6A illustrates a case where the first transmissive-reflective surface has a planar shape and the second transmissive-reflective surface has a concave shape toward the pupil plane side. In this case, the configuration is suitable for increasing the angle of view α, but is not suitable for reducing the emission angle β. FIG. 6B illustrates a case where both the first transmissive-reflective surface and the second transmissive-reflective surface have concave shapes toward the pupil plane side. In this case, the configuration is suitable for reducing the emission angle β and increasing the angle of view α. That is, considering only the influence of reflection, a configuration in which both the first transmissive-reflective surface and the second transmissive-reflective surface have concave shapes toward the pupil plane side as illustrated in FIG. 6B is suitable from the viewpoints of the emission angle β and the angle of view α. This can achieve a telecentric optical system described later.

In the present example, the shape of the R2 surface of the optical element 2111 followed by the first transmissive-reflective member and the shape of the R2 surface of the optical element 2122 followed by the second transmissive-reflective member are both concave toward the pupil plane side.

The present example assumes a shift amount equivalent to shifting the display element by 3 μm, which is half of one pixel, in the X and Y directions, so that spatial resolution appears doubled in the X and Y directions to a user.

The structure of the birefringent layers is determined so that a shift amount becomes a desired amount in a case where the desired light perpendicularly enters the super-resolution element 2141, as in a light beam at an angle of view α of zero. However, in a case where the desired light obliquely enters the super-resolution element 2141, as in a light beam at an angle of view α other than zero, a shift amount of the light beam varies according to the incident angle and deviates from the desired shift amount. In other words, the variation of the emission angle β due to the angle of view α may be reduced. To achieve this, in the present example, the observation optical system 2100 is configured as a telecentric optical system on the display element side.

The present embodiment assumes a maximum half angle of view of 33° as a design field angle in design nomenclature. More specifically, a maximum angle of a principal ray passing through the pupil plane is 33°.

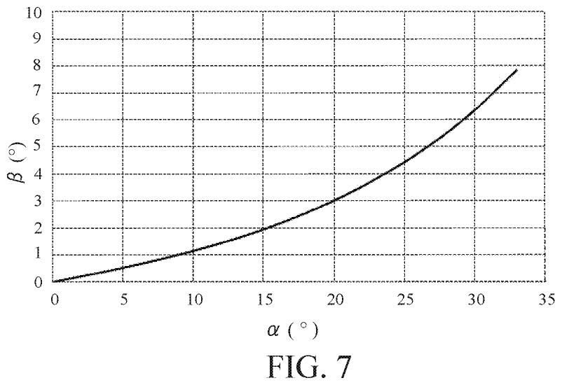

FIG. 7 illustrates, in the observation optical system 2100 of the present example, the emission angle β of the principal ray (an angle relative to a normal to the display element) against the angle of view α. In FIG. 7, a horizontal axis represents the angle of view α) (°, and a vertical axis represents the emission angle β (°). As illustrated, the emission angle β is defined as positive (+) when emitted in a direction away from the optical axis and negative (−) when emitted in a direction toward the optical axis. The emission angle β corresponds to an incident angle θ on the super-resolution element 2141.

In general, it is sufficient to achieve a telecentric optical system within a range of angle of view α<±30°, in which human visual sensitivity is high. Outside this range, even if a shift amount of a light beam deviates from half of one pixel, it is less likely to be noticed and is unlikely to cause a problem.

Considering a difference in optical path length of a light ray having an incident angle θ when passing through a birefringent layer relative to a case of perpendicular incidence, the difference is expressed as 1/cosθ-1. If a deviation in shift amount corresponding to an optical path length difference of about 1-1/coseθ≤1% is difficult to notice, a permissible range is the incident angle θ≤±8°.

That is, in the present example, the absolute value of the emission angle from the display surface of the display element of the principal ray that passes through the pupil plane SP with an absolute value of an incident angle of 30° or less may be 8° or less.

From FIG. 7, within a range of angle of view α<±30°, a maximum value θₘₐₓ of the incident angle θ is 6.4°, and a telecentric optical system sufficient for achieving higher resolution by the super-resolution element 2141 is provided, thereby enabling higher resolution. In order to satisfactorily reduce curvature of field and astigmatic difference while satisfying constraints of a telecentric optical system, at least one of the first transmissive-reflective surface and the second transmissive-reflective surface may be aspherical.

In the present example, both the shape of the R2 surface of the optical element 2111 followed by the first transmissive-reflective member and the shape of the R2 surface of the optical element 2122 followed by the second transmissive-reflective member are aspherical rather than spherical.

Since a super-resolution element often has a thickness of 3 mm or more, the thickness of the super-resolution element 2141 in the present example is 5 mm. Thus, a back focus may be increased in a reverse optical path (reverse tracing) from the pupil plane SP toward the display surface of the display element 2142 in a configuration excluding the display-element-side optical system 2140 from the observation optical system 2100. For example, a back focus may be 3 mm or more. In the present example, the back focus of the observation optical system 2100 is 5.38 mm.

From another viewpoint, the super-resolution element that requires thickness is compatible with a polarization optical system that facilitates thickness reduction to reduce the thickness of the observation apparatus.

If a distance from an optical surface facing the pupil plane SP (pupil-facing surface) to the display surface of the display element is 30 mm or less, the apparatus may be considered compact (thin), and the distance may be 25 mm or less. In the present example, the distance from the pupil-facing surface to the display element is 22.7 mm, and sufficient size reduction (thickness reduction) is achieved.

It is effective to achieve both the telecentric optical system described above and securing the back focus that facilitates placement of the super-resolution element. Letting the distance from the pupil-facing surface to the display surface of the display element be L and a focal length of the observation optical system 2100 be f, the following inequality may be satisfied: f/L≥1. In the present example, L=22.7 mm and f=24.43 mm; thus, f/L=1.08≥1 is satisfied.

The configuration in which the focal length is long relative to the distance from the pupil-facing surface to the display element can reduce the curvature of field in the case of the telecentric optical system and secure satisfactory imaging performance, while facilitating placement of the super-resolution element.

The observation optical system 2100 in the present example includes a total of three optical elements: one in the pupil-plane-side optical system and two in the transmissive-reflective optical system (optical elements 2111, 2121, and 2122). Since there is no optical element in the display-element-side optical system, the configuration is beneficial in terms of compactness (thinness). In addition, from the viewpoint of achieving a telecentric optical system and obtaining high imaging performance including reduction of chromatic aberration, a configuration having one optical element in the pupil-plane-side optical system and two optical elements in the transmissive-reflective optical system may be regarded as a configuration having a minimum number of optical elements. Thus, this configuration can provide the effect of the present disclosure while facilitating the cost reduction and manufacturability.

The present example can improve the resolution, secure high optical performance, and achieve the reduced size (thickness).

Numerical examples 1 and 2 corresponding to Examples 1 and 2 will be illustrated below. In surface data of each numerical example, a surface number i indicates an i-th surface counted from the pupil plane side. r represents a radius of curvature (mm) of the i-th surface, d represents a lens thickness or an air gap (mm) between i-th and (i+1)-th surfaces, and nd represents a refractive index at the d-line of a material of an i-th optical member. vd represents an Abbe number based on the d-line of the material of the i-th optical member. The Abbe number vd is expressed as vd=(Nd−1)/(NF-NC), where Nd, NF, and NC are refractive indices for the d-line (587.6 nm), F-line (486.1 nm), and C-line (656.3 nm) in the Fraunhofer line, respectively. The effective diameter indicates a maximum diameter of a region through which light from an original image passes at each surface.

An asterisk “*” attached to a surface number means that the surface has an aspherical shape. The aspherical shape is expressed by the following equation:

$$x ( h ) = \frac{( \frac{{h}^{2}}{r} )}{1 + \sqrt{\{ 1 - ( 1 + k ) {( \frac{h}{r} )}^{2} \}}} + {A}_{4} {h}^{4} + {A}_{6} {h}^{6} + {A}_{8} {h}^{8} + {A}_{10} {h}^{10} + …$$

where x is a displacement amount in an optical-axis direction at a position of height h from the optical axis from a surface vertex, R is a paraxial radius of curvature, k is a conic constant, and Ai (i=4, 6, 8, . . . ) are aspherical coefficients of respective orders.

### NUMERICAL EXAMPLE 1

UNIT: mm
SURFACE DATA

| Surface No. | r | d | nd | νd |
|---|---|---|---|---|
| 1 (SP) | ∞ | (Variable) | | |
| 2* | 85.300 | 5.60 | 1.49171 | 57.4 |
| 3* | −102.600 | 0.30 | 1.52000 | 50.0 |
| 4* | −102.600 | 2.00 | 1.64220 | 22.4 |
| 5 | ∞ | 0.30 | 1.52000 | 50.0 |
| 6 | ∞ | (Variable) | | |
| 7 | ∞ | 6.00 | 1.54390 | 56.0 |
| 8* | −51.300 | −6.00 | | |
| 9 | ∞ | (Variable) | | |
| 10 | ∞ | −0.30 | 1.52000 | 50.0 |
| 11 | ∞ | −2.00 | 1.64220 | 22.4 |
| 12* | −102.600 | 2.00 | | |
| 13 | ∞ | 0.30 | 1.52000 | 50.0 |
| 14 | ∞ | (Variable) | | |
| 15 | ∞ | 6.00 | 1.54390 | 56.0 |
| 16* | −51.300 | 4.80 | | |
| 17 | ∞ | 0.30 | 1.52000 | 50.0 |
| 18 | ∞ | 0.10 | 1.52000 | 50.0 |
| 19 | ∞ | 0.40 | 1.51633 | 64.1 |
| Image Plane | ∞ | | | |

| ASPHERIC DATA | | |
|---|---|---|
| 2nd Surface | | |
| K = 0.00000e+00 A 4 = 2.89442e−06 A 6 = −4.06920e−09 A 8 = −1.00976e−11 | | |
| 3rd Surface | | |
| K = 0.00000e+00 A 4 = 3.53359e−06 A 6 = −4.57754e−09 A 8 = 5.46043e−12 | | |
| 4th Surface | | |
| K = 0.00000e+00 A 4 = 3.53359e−06 A 6 = −4.57754e−09 A 8 = 5.46043e−12 | | |
| 8th Surface | | |
| K = 0.00000e+00 A 4 = 1.49626e−06 A 6 = 7.53956e−10 A 8 = −1.09097e−12 | | |
| 12th Surface | | |
| K = 0.00000e+00 A 4 = 3.53359e−06 A 6 = −4.57754e−09 A 8 = 5.46043e−12 | | |
| 16th Surface | | |
| K = 0.00000e+00 A 4 = 1.49626e−06 A 6 = 7.53956e−10 A 8 = −1.09097e−12 | | |
| | No Diopter Adjustment | −4D Adjustment |
| Focal Length | 21.43 | 21.56 |
| d1 | 15.00 | 15.54 |
| d6 | 1.20 | 0.66 |
| d9 | −1.20 | −0.66 |
| d14 | 1.20 | 0.66 |

### NUMERICAL EXAMPLE 2

UNIT: mm
SURFACE DATA

| Surface No. | r | d | nd | νd |
|---|---|---|---|---|
| 1 (SP) | ∞ | 15.00 | | |
| 2* | 85.300 | 5.60 | 1.49171 | 57.4 |
| 3* | −102.600 | 0.30 | 1.52000 | 50.0 |
| 4* | −102.600 | 2.00 | 1.64220 | 22.4 |
| 5 | ∞ | 0.30 | 1.52000 | 50.0 |
| 6 | ∞ | 1.20 | | |
| 7 | ∞ | 6.00 | 1.54390 | 56.0 |
| 8* | −51.300 | −6.00 | | |
| 9 | ∞ | −1.20 | | |
| 10 | ∞ | −0.30 | 1.52000 | 50.0 |
| 11 | ∞ | −2.00 | 1.64220 | 22.4 |
| 12* | −102.600 | 2.00 | | |
| 13 | ∞ | 0.30 | 1.52000 | 50.0 |
| 14 | ∞ | 1.20 | | |
| 15 | ∞ | 6.00 | 1.54390 | 56.0 |
| 16* | −51.300 | 1.50 | | |
| 17 | ∞ | 0.30 | 1.52000 | 50.0 |
| 18 | ∞ | 5.00 | 1.49170 | 57.4 |
| 19 | ∞ | 0.10 | 1.52000 | 50.0 |
| 20 | ∞ | 0.40 | 1.51633 | 64.1 |
| Image Plane | ∞ | | | |

ASPHERIC DATA
2nd Surface
K = 0.00000e+00 A 4 = 2.89442e−06 A 6 = −4.06920e−09 A 8 = −1.00976e−11
3rd Surface
K = 0.00000e+00 A 4 = 3.53359e−06 A 6 = −4.57754e−09 A 8 = 5.46043e−12
4th Surface
K = 0.00000e+00 A 4 = 3.53359e−06 A 6 = −4.57754e−09 A 8 = 5.46043e−12
8th Surface
K = 0.00000e+00 A 4 = 1.49626e−06 A 6 = −7.53956e−10 A 8 = −1.09097e−12
12th Surface
K = 0.00000e+00 A 4 = 3.53359e−06 A 6 = −4.57754e−09 A 8 = 5.46043e−12
16th Surface
K = 0.00000e+00 A 4 = 1.49626e−06 A 6 = 7.53956e−10 A 8 = −1.09097e−12

| | |
|---|---|
| Focal Length | 21.43 |

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

For example, when combined with a display element such as an Organic Light Emitting Diode (OLED) or a Liquid Crystal Display (LCD), electrical processing may be applied on a display side depending on a distortion amount or a lateral chromatic aberration amount. In each example, one of the first transmissive-reflective surface and the second transmissive-reflective surface may be a polarization-selective transmissive-reflective element (a reflective polarizer) PBS. In this case, the other of the first transmissive-reflective surface and the second transmissive-reflective surface may be a half-mirror having a ratio of transmittance to reflectance of 1:1. However, the ratio of transmittance to reflectance may be changed, as necessary. The optical system according to each example may further include another optical system (lens) on a pupil plane side of the first optical system. Similarly, the optical system according to each example may further include another optical system (lens) on a display-surface side of the third optical system.

Each example can provide an optical apparatus, an optical element, and a display apparatus, each of which has a reduced size (thickness) and high optical performance.

This application claims the benefit of Japanese Patent Application No. 2025-079147, filed on May 12, 2025, which is hereby incorporated by reference herein in its entirety.

What is claimed is:

1. An optical apparatus configured to guide a light beam from a display surface of a display element to a pupil plane, the optical apparatus comprising:
an optical system configured to guide a light beam having a specific polarization state to the pupil plane; and
a display element shift unit configured to shift the display element in a direction perpendicular to an optical axis of the optical system.

2. The optical apparatus according to claim 1, wherein the display element shift unit is configured to shift the display element in a first direction and in a second direction different from the first direction.

3. The optical apparatus according to claim 1, wherein the display element shift unit is configured to determine whether to shift the display element in accordance with display content of the display element.

4. The optical apparatus according to claim 1, wherein the display element shift unit is configured to determine whether to shift the display element in accordance with a user instruction.

5. An optical apparatus configured to guide a light beam from a display surface of a display element to a pupil plane, the optical apparatus comprising:
an optical system configured to guide a light beam having a specific polarization state to the pupil plane;
a light beam shift unit configured to shift the light beam in a direction perpendicular to an optical axis of the optical system by changing a polarization state of the light beam; and
a polarization adjuster configured to adjust the light beam shifted by the light beam shift unit so that the light beam has a specific polarization state.

6. The optical apparatus according to claim 5, wherein the light beam shift unit includes a liquid crystal layer configured to change the polarization state and a birefringent layer configured to shift the light beam in accordance with the polarization state.

7. The optical apparatus according to claim 5, wherein the light beam shift unit is configured to shift the light beam in a first direction and in a second direction different from the first direction.

8. The optical apparatus according to claim 5, wherein the light beam shift unit is configured to determine whether to shift the light beam in accordance with display content of the display element.

9. The optical apparatus according to claim 5, wherein the light beam shift unit is configured to determine whether to shift the light beam in accordance with a user instruction.

10. The optical apparatus according to claim 5, wherein an absolute value of an emission angle from the display surface of a principal ray that passes through the pupil plane with an absolute value of an incident angle of 30° or less is 8° or less.

11. The optical apparatus according to claim 1, wherein the optical system includes a first transmissive-reflective member having a first transmissive-reflective surface and a second transmissive-reflective member having a second transmissive-reflective surface, and
wherein at least one of the first transmissive-reflective member and the second transmissive-reflective member is a transmissive-reflective member configured to transmit or reflect the light beam in accordance with the polarization state.

12. The optical apparatus according to claim 11, wherein each of the first transmissive-reflective member and the second transmissive-reflective member has a concave shape toward a pupil plane side.

13. The optical apparatus according to claim 11, wherein at least one of the first transmissive-reflective surface and the second transmissive-reflective surface is aspherical.

14. The optical apparatus according to claim 11, wherein a back focus of the optical system is 3 mm or more.

15. The optical apparatus according to claim 11, wherein a distance from an optical surface facing the pupil plane to the display surface is 30 mm or less.

16. The optical apparatus according to claim 11, wherein the following inequality is satisfied:
f/L≥1
where f is a focal length of the optical system, and L is a distance from an optical surface facing the pupil plane to the display surface.

17. The optical apparatus according to claim 11, wherein the optical system further includes a second optical system disposed between the first transmissive-reflective member and the second transmissive-reflective member,
wherein the second optical system includes a first lens having negative on-axis power and a second lens having positive on-axis power, and
wherein the following inequality is satisfied:
20≤v2−v1
where v1 is an Abbe number based on a d-line of the first lens, and v2 is an Abbe number based on the d-line of the second lens.

18. The optical apparatus according to claim 17, wherein the following inequality is satisfied:
0.25≤|f2/f1|≤4.00
where f1 is a focal length of the first lens, and f2 is a focal length of the second lens.

19. The optical apparatus according to claim 17, wherein the optical system further includes a first optical system disposed between the pupil plane and the first transmissive-reflective member, and
wherein the first optical system includes a third lens having positive on-axis power.

20. The optical apparatus according to claim 11, wherein the optical system further includes a planar phase shifter disposed between the first transmissive-reflective member and the second transmissive-reflective member.

21. The optical apparatus according to claim 11, wherein an optical surface facing the pupil plane in the optical system is planar or has a convex shape toward a pupil plane side.

22. The optical apparatus according to claim 11, wherein an air gap is formed between the first transmissive-reflective member and the second transmissive-reflective member.

23. The optical apparatus according to claim 22, further comprising an adjustment mechanism configured to adjust a focus state by changing the air gap.

24. A display apparatus comprising:
an optical apparatus configured to guide a light beam from a display surface of a display element to a pupil plane; and
the display element,
wherein the optical apparatus includes:
an optical system configured to guide a light beam having a specific polarization state to the pupil plane; and
a display element shift unit configured to shift the display element in a direction perpendicular to an optical axis of the optical system.
